(19) United States
(12) Patent Application Publication
(10) Pub. No.: US 2005/0089029 A1
(43) Pub. Date: Apr. 28, 2005

(54) Method for operating a transmission system and transmission system in an energy supply network

(76) Inventors: Heiko Ruhnke, Munchen (DE); Harry Siebert, Puchheim (DE)

Correspondence Address: STAAS & HALSEY LLP, SUITE 700, 1201 NEW YORK AVENUE, N.W., WASHINGTON, DC, 20005, US

(21) Appl. No.: 10/491,136

(22) PCT Filed: Sep. 20, 2002
(86) PCT No.: PCT/DE02/03536

(30) Foreign Application Priority Data
Sep. 27, 2001 (DE) 101 47 772.4

(51) Int. Cl. H04L 12/28

(52) U.S. Cl. 370/389; 340/310.01; 370/254

(57) ABSTRACT

At least one centralized transmission facility is connected via the power supply lines of the power supply network to the decentralized transmission facilities with a decentralized repeater function being appropriately positioned in the power supply network in the event of there being insufficient transmission range of the centralized to the decentralized transmission facilities. According to the invention, part of the decentralized transmission facilities are additionally fitted with repeater functions in such a way that they can be configured via the centralized transmission facility as a decentralized transmission facility and/or as a decentralized transmission facility with a repeater function. In this way, if centralized transmission facilities cannot be reached, an alternative path is determined and the transmission system is automatically reconfigured.

### CROSS REFERENCE TO RELATED APPLICATIONS

This application is based on and hereby claims priority to German Application No. 101 47 772.4 filed on Sep. 27, 2001, the contents of which are hereby incorporated by reference.

### BACKGROUND OF THE INVENTION

In addition to wired and wireless telecommunication lines, the power supply lines of power supply networks are increasingly used for the transmission of information, particularly information from the Internet. For this purpose, at least one centralized transmission facility, known in technical parlance as a powerline modem, is usually provided, that is connected via the power supply lines of the power supply network to decentralized transmission facilities with, in the case of Internet information transmission, the centralized facility being directly connected to the Internet and the decentralized transmission facilities being connected to an Internet terminal, for example a computer. Because the transmission range of the transmission facilities is limited, if the transmission range of the centralized transmission facility to the decentralized transmission facilities in the power supply network is insufficient at least one repeater transmission facility, i.e. a decentralized repeater function, is positioned in the power supply network in such a way that transmission of information from the centralized to the decentralized transmission facilities and vice versa is possible. The repeater transmission facility is usually positioned in such a way that information communication takes place over the shortest or most direct route. To guarantee information communication in the event failure of repeater transmission facilities of this kind, it is important that redundant repeater transmission facilities be held in reserve in the power supply networks, via which redundant facilities the information communication is rerouted by a network management function of the transmission system. This necessitates additional financial expenditure.

### SUMMARY OF THE INVENTION

An object of the invention is to reduce the cost of the redundancy of the repeater transmission facilities. This object is achieved, starting with a method for operating a transmission system in a power supply network or a transmission system.

The essential aspects of the method in accordance with the invention or of the inventive transmission system is to be seen in that at least a part of the decentralized transmission facilities are additionally provided with repeater functions such that they can be configured from the decentralized transmission facility as a decentralized transmission facility and/or as a repeater transmission facility. The essential advantage of the integration of the repeater transmission facility or of the repeater function in the decentralized transmission facilities is that a large part of the components present in the decentralized transmission facilities, such as coupling and transmission technology can also be used for the realization of the repeater function and thus a substantial reduction in the financial cost of the repeater function can be achieved. The protocol computers of the decentralized transmission facilities are merely to be provided with a general protocol platform with which both the functions of the decentralized transmission facility and also the functions of the repeater function can be realized, with an economic realization of the protocol platform being achieved due to the increasing power of processors, computers and memories combined with cost reduction. A further advantage of the method in accordance with the invention is that the reconfiguration is automatically controlled without the intervention of maintenance personnel, with the information communication of the transmission facilities not affected by the reconfiguration not being disturbed.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a schematic block diagram of a transmission system in a power supply network.

FIG. 2 is a schematic block diagram of the transmission system arranged and reconfigured according to FIG. 1 after a partial failure of the power supply network.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

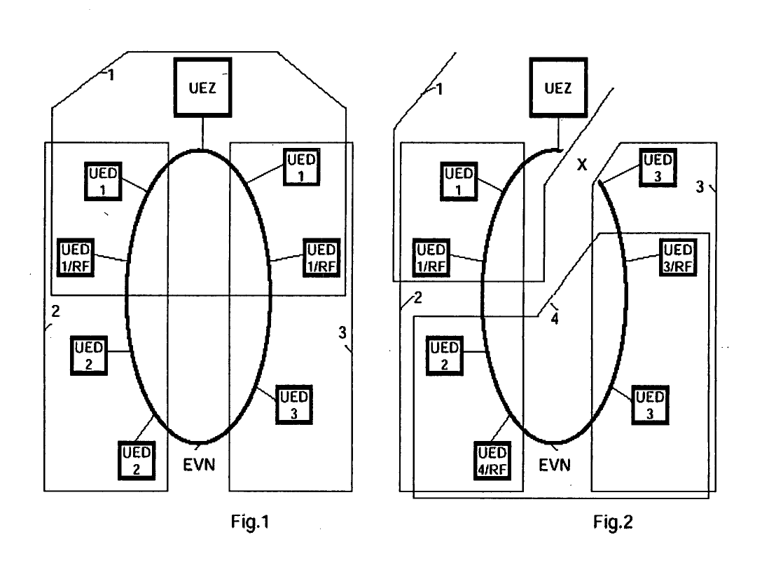

FIG. 1 and FIG. 2 each show a power supply network EVN, represented by an oval line, of power supply lines (not illustrated) to which several transmission facilities UE are connected, that together form a transmission system for the communication of information via a power supply network EVN. For the exemplary embodiment it is assumed that a central transmission facility UEZ and the remaining transmission facilities UE are, as decentralized transmission facilities UED, connected to the power supply network EVN. A transmission system of this kind serves, for example, to connect the personal computers connected to the decentralized transmission facilities UED to the Internet (not illustrated) via the power supply network EVN and the centralized transmission facility UEZ, with the establishment and clearing of the connections necessary for the Internet information exchange, including resource and network management, being coordinated by the centralized transmission facility UEZ.

The decentralized facilities UED are, according to the invention, configurable as decentralized transmission facilities UED with and without a repeater function RF, i.e. the properties of the decentralized transmission facilities UED can be remotely set by a network management function, that is realized within or outside the transmission system, corresponding to the geographical conditions of the power supply network EVN and the transmission ranges of the transmission facilities UE, with the transmission ranges being essentially determined by the transmission method used and the propagation conditions.

In the example of a configuration, two transmission facilities UED1 without a repeater function RF are configured in range area 1 of the centralized transmission facility UEZ and at the limits of range area 1 two transmission facilities UED1/RF each with a repeater function RF are configured. A range area 2, 3, shown by doted lines, is assigned to each of the transmission facilities UED1/RF with a repeater function RF. In these range areas 2, 3, further transmission facilities UED2, UED3 are connected to the power supply network EVN, with these transmission facilities UED2, UED3 being arranged outside range area 1 of the centralized transmission facility UEZ. With the aid of the repeater function RF in the decentralized transmission facilities UED/RF, further remote decentralized transmission facilities UED, that otherwise can no longer communicate with the centralized transmission facility UEZ, are connected to the centralized transmission facility UEZ, with the repeater function RF essentially realizing the reception and re-transmission of the relevant transmission signals. This re-transmission forms a further range area 2,3 over which further remote decentralized transmission facilities UED can be reached and can communicate with the centralized transmission facility UEZ in the sense of a data exchange, for example for Internet connections. This means that the paths for the information exchange between the centralized and decentralized transmission facilities UEZ/UED are established and these paths including the configuration of the transmission facilities UE are defined with or without a repeater function RF and stored in the centralized transmission facility UEZ as a topology of the transmission system. This also includes the ranges 1 . . . 3 of the relevant transmission facilities UED/RF that are determined by the transmission range of the particular transmission facilities UE.

The increasing availability of inexpensive components of transmission facilities UE, such as low-cost memories or computers, makes it possible, based on existing components such as housings, power supply assemblies and circuit boards and particularly using existing coupling and transmission technology, to additionally integrate the repeater function RF economically into the transmission facilities UE. All that is additionally required is to realize a technical program platform for the various protocols necessary for the decentralized function of the transmission facility UEZ and the repeater function RF, with it being possible to achieve the technical program realization particularly economically. The activation or configuration of the repeater function RF in the decentralized transmission facilities UED is controlled by a network management function that is realized in the central transmission facility UEZ or in higher-level network management centers (not illustrated) connected to the centralized transmission facility UEZ.

If it is determined, for example by a temporary or continuous monitoring of the transmission system or by a message from a subscriber using the transmission system, that decentralized transmission facilities UED can no longer be reached, an alternative path is determined in the centralized transmission facility UEZ or in a higher-level network management system (not illustrated) by the topology data of the transmission system stored there, and decentralized transmission facilities UED are configured with regard to their repeater function RF in such a way that the unreachable transmission facility UE can again be reached. In this case it should be noted that the original configuration of the transmission system has already been carried out in such a way that an alternative path is possible. With the exemplary embodiment, let us assume that an interruption in the transmission between the centralized transmission facility UEZ and one of the decentralized transmission facilities UED 1 occurs, or is reported, at the point marked X in FIG. 2 and the decentralized transmission facility UED1 can no longer be reached from the centralized transmission facility UEZ.

An alternative path from the decentralized to the no longer reachable decentralized transmission facility UED1 is determined in the centralized transmission facility UEZ or by the network management function. The newly determined path leads from the centralized transmission facility UEZ via its range area 1, restricted due to the fault in the power supply network, to the decentralized transmission facility UED1/RF with the assigned range area 2 and to the decentralized transmission facility UED2 arranged at the limit of its range area 2. This transmission facility UED2, that up until now has been configured without a repeater function RF, is to be provided with a repeater function RF for the newly determined path, with this having a range area 4 by which the decentralized transmission facility UED1/RF with range area 3 can be reached. Because the unreachable transmission facility UED1 is arranged in range area 3 of transmission facility UED1/RF, this can now be reached through the newly determined path via transmission facility UED1/RF with range area 3. In accordance with the invention, with the aid of the network management function in the centralized transmission facility UEZ or in a higher-level facility (not illustrated), the decentralized facility UED2 is configured at the limit of range area 2 with a repeater function RF with a range area 4 and the decentralized transmission facility UED1/RF with range 3 is configured as transmission facility UED3/RF that can no longer be reached from the centralized transmission facility UEZ but instead from transmission facility UED4/RF with range area 4, with transmission facilities UED3, arranged in range area 3, being reached via decentralized transmission facility UED3/RF.

Both the detection of the unreachability of decentralized transmission facilities UED and the complete reconfiguration of the transmission system including determining alternative paths can automatically be performed without the intervention of maintenance personnel by a network management function in the centralized transmission facility UEZ or in a higher-level facility, for example a network management center. A further advantage of the method in accordance with the invention is that the transmission of information at transmission facilities UE not involved in the reconfiguration is not disturbed, i.e. the reconfiguration measures remain limited to those transmission facilities UE whose repeater function RF is configured and whose assignment to transmission facilities UED with repeater function RF or to other range areas 1 . . . 4 is changed.

An advantageous reconfiguration of transmission facilities UE can be achieved by strategic planning of the configuration of the transmission system taking account of failure areas. In this way, the transmission facilities UE, that are fitted with a repeater function RF and can be configured with range areas, are positioned in the transmission system in such a way that in the event of transmission facilities UE being unreachable via these transmission facilities UE with a repeater function RF and their range areas, alternative paths to the unreachable transmission facilities UED can be determined and configured.

The invention has been described in detail with particular reference to preferred embodiments thereof and examples, but it will be understood that variations and modifications can be effected within the spirit and scope of the invention.

1-8. (canceled)

9. A method for operating a transmission system in a power supply network having at least one centralized transmission facility connected via power supply lines to decentralized transmission facilities, comprising:
providing a decentralized repeater function at an appropriate position in the power supply network for an inadequate transmission range of the centralized transmission facilities to the decentralized transmission facilities; and
providing at least some of the decentralized transmission facilities with repeater functions to be configured when needed in accordance with a network management function in one of the centralized transmission facility, the power supply network and the decentralized transmission facilities, as a function of a network topology of the power supply network and transmission ranges of the decentralized transmission facilities.

10. A method according to claim 9, further comprising, when a decentralized transmission facility is unreachable, automatically configuring other decentralized transmission facilities and the repeater function thereof in accordance with the network management function and the network topology of the power supply network assigned to the network management function to enable communication between the centralized and decentralized transmission facilities.

11. A method according to claim 10, further comprising when one of the decentralized transmission facilities is unreachable
determining an alternative path for the communication of information from the centralized transmission facility to the one of the decentralized transmission facilities using affected decentralized transmission facilities in accordance with the network management function; and
configuring at least some of the affected decentralized transmission facilities with the repeater function as required by the alternative path.

12. A method according to claim 11, further comprising during at least one of an initialization and a reconfiguration planned as part of one of expansion and reduction of the transmission system, configuring the decentralized transmission facilities and the repeater functions thereof in accordance with the network management function and the network topology of the power supply network assigned to the network management function to achieve a shortest possible transmission path.

13. A method according to claim 9, further comprising
configuring the transmission system with the at least some of the decentralized transmission facilities with the repeater function having a range area and positioned so that alternative paths are available to any unreachable transmission facilities; and
determining relevant decentralized transmission facilities to be configured with the repeater function thereof when any of the decentralized transmission facilities become unreachable.

14. A transmission system in a power supply network of power supply lines, comprising:
at least one centralized transmission facility; and
decentralized transmission facilities connected via the power supply lines of the power supply network to said at least one centralized transmission facility, including
a first group of said decentralized transmission facilities having a decentralized repeater function and appropriately positioned in the power supply network when there is insufficient transmission range of said at least one centralized to reach all of the decentralized transmission facilities; and
a second group of the decentralized transmission facilities having a configurable repeater function that is configured when needed.

15. A transmission system according to claim 14, further comprising a network management function for configuring said centralized and decentralized transmission facilities.
